(19) United States
(12) Patent Application Publication
(10) Pub. No.: US 2021/0192906 A1
(43) Pub. Date: Jun. 24, 2021

(54) SURVEILLANCE SYSTEMS AND DEVICES THEREFOR

(71) Applicant: Jeetendra KOCHAR, Balaghat, Madhya Pradesh, Maharashtra (IN)

(72) Inventor: Jeetendra KOCHAR, Balaghat, Madhya Pradesh, Maharashtra (IN)

(21) Appl. No.: 17/258,536

(22) PCT Filed: Jun. 3, 2019
(86) PCT No.: PCT/IB2019/054563

§ 371 Date: Jan. 7, 2021

(30) Foreign Application Priority Data
Sep. 26, 2018 (IN) 201821036359

(51) Int. Cl. G08B 13/196; H04L 29/06; H04N 7/18; H04N 5/77

(52) U.S. Cl. CPC G08B 13/19621; H04L 65/4069; H04N 5/04; H04N 5/77; G08B 13/1966; H04N 7/185

(57) ABSTRACT

A surveillance system (100) comprising a surveillance device (102) having a wearable unit (102) adapted to be worn by a user and a remote server (106). The surveillance device (102) comprising: a processing unit (202), audio capturing means (206) configured to capture audio in a surrounding of said wearable unit (102′) to provide audio captured data, video capturing means (208) configured to capture a video imagery of things in front of said wearable unit to provide video captured data, and transmission means (210) configured to transmit captured data from said audio capturing means (206) and video capturing means (208) in real-time to a remote location. The remote server (106) configured to save the received data for a remote surveillance team. The remote server (106) upon receiving an activation signal from the user extracts data from saved data of a predefined duration in a most-recent past for review.

### FIELD OF INVENTION

The present disclosure relates to surveillance systems and devices.

### BACKGROUND

The background information herein below relates to the present disclosure but is not necessarily prior art.

The popularity of surveillance devices has increased manifold due to increasing crime rates in cities and metros. Conventional surveillance systems or devices such as Closed Circuit Television (CCTV) cameras monitor our surroundings, like in and around our homes and offices, and capture video for display as well as the videography for future playback. A CCTV camera footage can be used as an evidence in a crime investigation. A drawback of having a CCTV based surveillance is that it is non-reactive kind of surveillance.

Another conventionally used surveillance system is drone-based surveillance system. Drone based surveillance systems can be employed for crucial military missions, investigation of crime scene, and the like. The drone based surveillance has certain restrictions in the sense that it may amount to aerial trespassing. Further, usage of drones in flying applications requires a legal license. Adding up to the complications, a high quality camera is required along with a physically stable drone, which may be a costly setup.

Therefore, there is a long felt need to provide a surveillance system or device that alleviates the aforementioned drawbacks of the conventional surveillance systems.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a surveillance device that is able to provide quick reactive intelligence for security/law enforcement agencies.

Another object of the present disclosure is to provide a surveillance device that is dynamic in its videography capability.

Yet another object of the present disclosure is to provide a surveillance device that is cost effective yet efficient in terms of achieving its end objective.

Other objects and advantages of the present disclosure will be more apparent from the following description, which is not intended to limit the scope of the present disclosure.

### SUMMARY

The present invention envisages a surveillance system comprising: a surveillance device having a wearable unit adapted to be worn by a user and a server communicatively coupled to the surveillance device. The wearable unit comprises a processing unit, a memory coupled to the processing unit, the memory configured to store instructions which when executed by the processor provides for one or more executable commands, audio capturing means configured to capture audio in a surrounding of the wearable unit to provide audio captured data, video capturing means configured to capture a video imagery of things in front of the wearable unit to provide video captured data, and transmission means configured to transmit captured data from the audio capturing means and video capturing means in real-time to a remote location.

The surveillance device is configured to send the captured data from the wearable unit to a remote server for display the same on a display device. The remote server is configured to save the captured data. In an embodiment, the surveillance device, upon receiving an activation signal from the user, sends a first signal to the remote server to instruct the remote server to extract data from saved captured data of a predefined duration in a most-recent past for review and save a copy of extracted data.

In an embodiment, the wearable unit is configured to route the captured data to the remote server via a support unit, wherein the support unit is configured to power the wearable unit.

In another embodiment, the processing unit is configured to pre-process the captured video data and audio data before transmitting the captured data to the remote server.

In yet another embodiment, the pre-processing comprises syncing the audio captured data and the video captured data before transmitting to the remote server.

In still another embodiment, the pre-processing comprises filtering, cleaning, normalization, transformation, feature extraction and selection.

In a further embodiment, the wearable unit is a pair of eye glasses.

In a still further embodiment, the wearable unit is configured to receive the copy of extracted data from the remote server.

In an embodiment, the wearable unit sends a second signal simultaneously with the first signal to the remote server to alert the remote surveillance team and playback the data extracted by the remote server upon receiving of the first signal.

In another embodiment, the wearable device includes a display device configured to playback the copy of extracted data received from the remote server.

In yet another embodiment, the wearable unit is configured to receive instructions for the user from the remote surveillance team.

### BRIEF DESCRIPTION OF ACCOMPANYING DRAWING

A surveillance system of the present disclosure will now be described with the help of the accompanying drawing, in which:

FIG. 1 illustrates an exemplary surveillance system, in accordance with an embodiment of the present disclosure;

FIG. 2 illustrates a block diagram of a surveillance device of the surveillance system of FIG. 1; and

FIG. 3 illustrates an exemplary wearable unit of the surveillance device, in accordance with another embodiment of the present disclosure.

### LIST OF REFERENCE NUMERALS USED IN DETAILED DESCRIPTION AND DRAWING

100—Surveillance system
102—Surveillance device
102′—Wearable unit
104—Support unit
106—Remote station
202—Processing unit
204—User interface
206—Audio capturing means
208—Video capturing means
210—Transmission means
212—Information Block
214—Data
216—Other data
A—Eyewear
B—Display module
C—Video camera
D—Flash light
E—Processing module
F—Button
G—Voice capturing module
H—Audio output module
I—Connection wire/transceiver module

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The present disclosure envisages a surveillance system, wherein a wearable surveillance device worn by a user captures and transmits live video/audio feeds to a remote server. A surveillance team can watch and hear the data captured by the wearable surveillance device through an interactive media device, such as, an LED display and provide instructions to a user of the wearable device based on a quick assessment of the situation. The surveillance system of the present disclosure facilitates bidirectional communication between the user of the wearable surveillance device and the surveillance team thus making it a reactive kind of surveillance.

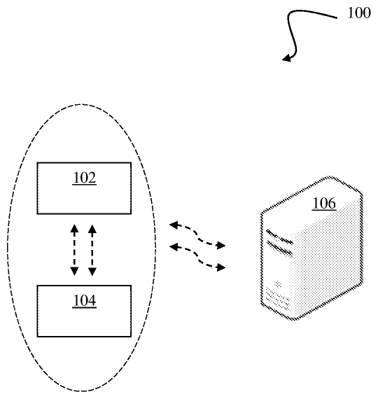

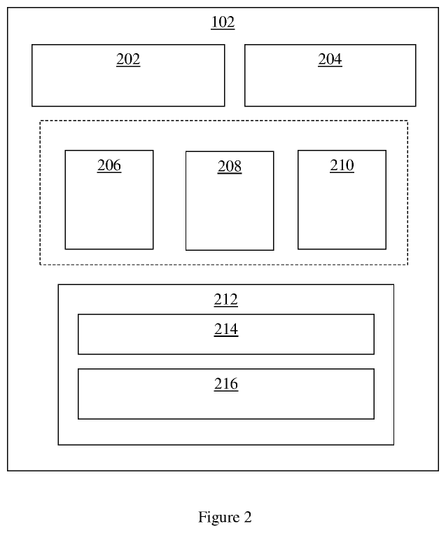

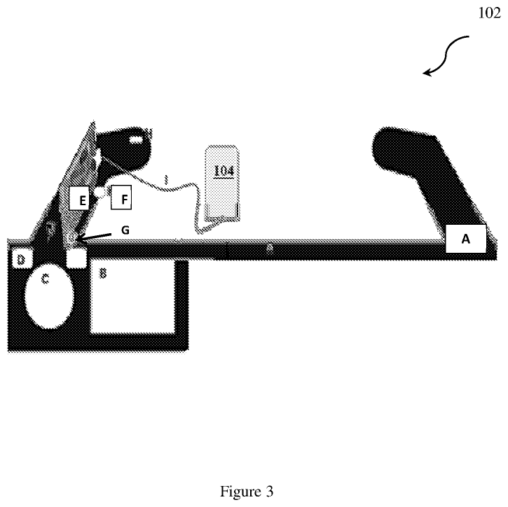

The surveillance system 100 (hereinafter referred as “system 100”) of the present disclosure is now being described with reference to FIG. 1, FIG. 2, and FIG. 3.

The surveillance system 100 of the present disclosure, in accordance with FIG. 1, includes a surveillance device 102 configured to communicate with a remote server 106. In an embodiment, the surveillance device 102 is a wearable device having a wearable unit 102′ (shown in FIG. 3) adapted to be worn by a user, such as a security guard. The surveillance device 102 is configured to capture audio and/or video in real-time and transmit the same to the remote server 106, where a surveillance team monitors captured data as received and provides actionable intelligence and/or instructions to the user. In an embodiment, the surveillance device 102 stores the audio/video captured in a memory of the surveillance device 102. In another embodiment, the remote server 106 also stores the data received from the surveillance device 102 for a pre-defined period of time, for example, a week's data. In yet another embodiment, the surveillance device 102 is configured to delete the captured data once transferred to the remote server 106.

In an embodiment, the surveillance device 102 is in communication with a support unit 104, which is configured to power the surveillance device 102, through wired or wireless means, as well as route the transmission from the surveillance device 102 to the remote server 106. In an embodiment, the surveillance device 102 and the support unit 104 are paired with each other to facilitate data transfer there between. In an embodiment, the support unit 104 is configured to communicate with the remote server 106 over a network (not shown), wired or wireless, as will be appreciated by people skilled in the art.

In an embodiment, the wearable unit 102′ is securely mounted to a headgear. In another embodiment, the wearable unit 102′ is in the form of an eyewear, such as sunglasses, spectacles and the like. However, it will be appreciated by a person skilled in the art that other wearable forms of the wearable unit 102′ may also be envisioned as obvious modifications to the ones mentioned above by way of example only.

In an embodiment, the support unit 104 is a handheld device having communication and processing capabilities. For example, the support unit 104 may include, but not limited to, a mobile phone, a smartphone, an iPad, a tablet, a palmtop and the like.

In implementation, the user wearing the wearable unit 102′ of the surveillance device 102 initiates capturing, for example, by pressing a button or by giving a voice command to the surveillance device 102. In an embodiment, the wearable unit 102′ is configured to convert the pressing of the button or giving of the voice command into an activation signal for the surveillance device 102 to get activated.

In an embodiment, the wearable unit 102′ includes a microphone through which the user provides an audio command. In another embodiment, the wearable unit 102′ includes a push button, which when pushed, activates the surveillance device 102 into performing various operations as will be explained below in detail.

In an embodiment, the surveillance device 102 is configured to continuously capture audio and/or video through the wearable unit 102′ and stream the audio/video data to the remote server 106, either directly or through the support device 104. In case of an event happening near the user, say an accident, the user may push the push button or give a voice command to activate the surveillance device 102. The surveillance device 102, upon receiving the activation signal from the user, sends a first signal to the remote server 106 to instruct the remote server 106 to extract data from saved captured data of a predefined duration in a most-recent past for review and save a copy of extracted data.

In an embodiment, the activation of the surveillance device 102 also activates a display module on the wearable unit 102′, for example, a display provided on a lens of a spectacle kind wearable unit 102′. In another embodiment, the activation of the surveillance device 102 may also start emergency calling.

FIG. 2 illustrates the surveillance device 102 includes a processing unit 202, a memory 204, audio capturing means 206, video capturing means 208, transmission means 210, and an information block 212. In an embodiment, the information block 212 includes data 214 and other data 216.

The memory 204 is configured to store a set of pre-determined instructions that include operating commands for the surveillance device 102. The memory may include any computer-readable medium known in the art including, for example, a volatile memory, such as static random access memory (SRAM) and dynamic random access memory (DRAM), and/or a nonvolatile memory, such as read only memory (ROM), erasable programmable ROM, flash memories, hard disks, optical disks, and magnetic tapes, and/or a cloud based storage (cloud storage).

The processing unit 202 can be implemented as one or more microprocessors, microcomputers, microcontrollers, digital signal processors, central processing units, state machines, logic circuitries, and/or any devices that manipulate signals based on operational instructions. Among other capabilities, the processing unit 202 is configured to fetch and execute the set of pre-determined instructions from the memory 204 which when executed provides for one or more executable commands.

In an embodiment, the surveillance device 102, once powered on, is configured to start capturing audio/video data through means 206 and 208 and transmit the captured data using the transmission means 210 to the support device 104, for example, through wired or wireless means. The support device 104 then transmits the data as received from the surveillance device 102 to the remote server 106. In an embodiment, the surveillance device 102 pre-processes the captured data before sending it any further, for example, using image processing techniques, noise reductions techniques and the like. In an embodiment, the pre-processing may occur in the support device 104 as well. In an embodiment, the processing unit 202 pre-processes the captured data before sending it to the support unit 104 simultaneously with the capturing of audio/video data. In another embodiment, the pre-processing includes syncing the audio captured data and video captured data. In yet another embodiment, the pre-processing includes, but not limited to, filtering, cleaning, normalization, transformation, feature extraction and selection.

In an instance, the user can select using a user interface (not shown) of the wearable unit 102′, the captured data that is required to be processed. For example, the user may select processing of video data only and exclude the audio data. The user may also specify the duration of the captured data that is required to be retained and processed. For example, from a 20 minutes long video, the user may specify selecting a portion of the video for processing. In an embodiment, the user interface may include a touch-based interface provided on the wearable unit 102′. In another embodiment, the surveillance device 102 is configured to store the captured data in the memory 204.

In an embodiment, the audio capturing means 206 may include a microphone. In another embodiment, the video capturing means 208 can capture videos and images in high definition and night vision mode. Both the means 206 and 208 are embedded in the wearable unit 102′. In yet another embodiment, the user may provide an initiation command for activating a flashlight.

The remote server 106 is configured to receive the captured data from the wearable unit 102′ and display the same for a remote surveillance team on a display. In an embodiment, the remote server 106 is configured to save the captured data for a predefined duration, after which the data is cleaned up or sent to an archive database (not shown). In an embodiment, the remote server 106 sends a copy of extracted data to the wearable unit 102′ as well for the user to view it on its wearable unit 102′, for example, for verification that correct data has been extracted out of the saved data.

In an embodiment, the wearable unit 102′ sends a second signal simultaneously with the first signal to the remote server 106 to alert the remote surveillance team. In another embodiment, upon receiving the second signal the team playbacks the data extracted by the remote server 106 upon receiving of the first signal. In yet another embodiment, the wearable device 102′ includes a display device configured to playback the copy of extracted data received from the remote server 106.

The wearable unit 102′ is configured to receive instructions for the user from the remote surveillance team via the transmission means 210. In an embodiment, the wearable unit 102′ is configured to store a video frame of video captured data or an image as a reference, in case the surveillance team identifies the same as an alarming event. For example, if the video frames are identified as a ‘fire event’, the transmission means 210 transmits the corresponding video frames to the other data 216 of the information block 212 for the storage purposes.

FIG. 3 illustrates an exemplary surveillance device 102 in the form of an eyewear. The surveillance device 102 includes an eyewear A, a display module B, a video camera C, a flashlight D, a processing module E, a button F, a voice capturing module G, an audio output module H, and a connection wire/transceiver module I.

In an embodiment, the display module B can be selected from a group consisting of a see-through display, a monocular display, a binocular display or a lens display. In another implementation, the display module B is configured to display a captured data that is being transmitted to a remote server 106. In yet another implementation, the display module B and the video camera C are at such an angle that do not block vision field of a user. In still another embodiment, the dimension and the resolution of the display module B is selected such that the vision of the user is not hampered or affected.

The video camera C is configured to perform zoom-in and zoom out functions to focus a view that is being captured. In an implementation, the video camera C is configured to provide auto-focus functionality. In another implementation, the configuration of the wearable device can be in various options, such as, camera can be positioned to left, right or center of the eyewear A.

In an embodiment, the processing module E includes a navigation module (not shown in the figure) configured to continuously track a location of the user. In one embodiment, the navigation module is configured to provide current location of the user, at pre-determined intervals, in latitude and longitudes on the display module B. Further, the navigation module is configured to provide the current location of the user to the remote server 106 via the transceiver module I.

In an embodiment, the wearable device 102′ enables the user to communicate with the surveillance team in real-time deployed at the remote station 106 by means of the audio output module H and the voice capturing module G.

In an embodiment, the processing module E is configured to perform facial detection, object detection, facial recognition, object recognition, intruder alarm, red light violation detection, speed radar, automated number plate recognition, prisoner management, visitor authentication, and the like.

In an embodiment, the surveillance device 102 can be an edge computing device. In yet another embodiment, the surveillance device 102 is an artificially intelligent device configured to employ machine learning algorithms.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

### Technical Advancements

The present disclosure described herein above has several technical advantages including, but not limited to, the realization of a surveillance system for surveillance that:
provides for reactive-kind of surveillance in real-time;
supports bi-directional communication;
does not have legal restrictions;
is cost effective;
is light weight;
doesn't obstruct user's vision; and
is easy to use and implement.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A surveillance system (100) comprising:
a surveillance device (102) having a wearable unit (102′) adapted to be worn by a user, said surveillance device (102) comprising:
a processing unit (202);
a memory (204) coupled to said processing unit (202), said memory (204) configured to store instructions which when executed by said processing unit (202) provides for one or more executable commands;
audio capturing means (206) configured to capture audio in a surrounding of said wearable unit (102′) to provide audio captured data;
video capturing means (208) configured to capture a video imagery of things in front of said wearable unit to provide video captured data; and
transmission means (210) configured to transmit captured data from said audio capturing means (206) and video capturing means (208) in real-time to a remote location; and
a remote server (106) communicatively coupled to the surveillance device (102) and configured to receive said captured data from said wearable unit (102′) of the surveillance device (102) and display the same on a display, wherein said remote server (106) is configured to save said captured data, wherein said surveillance device (102), upon receiving an activation signal from said user, sends a first signal to said remote server (106) to instruct said remote server (106) to extract data from saved captured data of a predefined duration in a most-recent past for review and save a copy of extracted data.

2. The surveillance system (100) as claimed in claim 1, wherein said wearable unit (102′) is configured to route said captured data to said remote server (106) via a support unit (104), wherein said support unit (104) is configured to power said wearable unit (102′).

3. The surveillance system (100) as claimed in claim 1, wherein said processing unit (202) is configured to pre-process said captured video data before transmitting said captured data to said remote server (106).

4. The surveillance system (100) as claimed in claim 3, wherein said pre-processing comprises syncing said audio captured data and said video captured data before transmitting to said remote server (106).

5. The surveillance system (100) as claimed in claim 3, wherein said pre-processing comprises filtering, cleaning, normalization, transformation, feature extraction and selection.

6. The surveillance system (100) as claimed in claim 3, wherein said wearable unit (102′) is a pair of eye glasses.

7. The surveillance system (100) as claimed in claim 1, wherein said wearable unit (102′) is configured to receive said copy of extracted data from said remote server (106).

8. The surveillance system (100) as claimed in claim 1, wherein said wearable unit (102′) sends a second signal simultaneously with said first signal to said remote server (106) to alert said remote surveillance team and playback said data extracted by said remote server (106) upon receiving of said first signal.

9. The surveillance system (100) as claimed in claim 7, wherein said wearable device (102′) includes a display module configured to playback said copy of extracted data received from said remote server (106).

10. The surveillance system (100) as claimed in claim 1, wherein said wearable unit (102′) is configured to receive instructions for said user from said remote surveillance team.
